(19) United States
(12) Patent Application Publication
(10) Pub. No.: US 2013/0047875 A1
(43) Pub. Date: Feb. 28, 2013

(54) VARIABLE SIGNATURE INDEXING DEVICE

(71) Applicants: Dieter Theodor Ebert, Stratham, NH (US); Joseph Adrian St. Ours, Lee, NH (US); David Elliot Whitten, Barrington, NH (US)

(72) Inventors: Dieter Theodor Ebert, Stratham, NH (US); Joseph Adrian St. Ours, Lee, NH (US); David Elliot Whitten, Barrington, NH (US)

(73) Assignee: Goss International Americas, Inc., Durham, NH (US)

(21) Appl. No.: 13/216,481

(22) Filed: Aug. 24, 2011

(51) Int. Cl. B41F 13/56

(52) U.S. Cl. 101/226; 101/483

(57) ABSTRACT

A printing press is provided that includes at least one variable cutoff printing unit printing images of at least one cutoff length on a web, at least one cutting cylinder downstream of the at least one variable cutoff printing unit cutting the web into signatures. The printing press also includes a pair of first accelerator nip rolls receiving the web as the web is cut into the signatures and accelerating each of the signatures and at least one motor accelerating the pair of first accelerator nip rolls such that the first accelerator nip rolls have a first surface velocity equal to a velocity of the web as the web is received by the first accelerator nip rolls and the first accelerator nip rolls have a second surface velocity greater than the first surface velocity as the first accelerator nip rolls release each of the signatures. A folder and a method of operating a folder are also provided.

The present invention relates generally to printing press folders and more specifically to a method and apparatus for cutting and transporting signatures in printing press folders.

### BACKGROUND OF THE INVENTION

Conventionally, in many pinless folders and former folders a gap between a trailing edge of one signature and a leading edge of a following signature, i.e., the head to tail spacing between successive signatures, must be created in order to perform folder operations after signatures are created by cutting ribbons or a web. Accelerator tapes are commonly used to produce the gaps between signatures. The accelerator tapes, which are traveling at a velocity greater than the velocity of the ribbons as the ribbons are cut and fed into the accelerator tapes, grip the ribbons before the ribbons are cut. Due to the greater velocity of the accelerator tapes, the accelerator tapes sometimes damage the signature being created by rubbing on the ribbons. Once the signature is created, the accelerator tapes instantaneously accelerate the signature to create a spacing between a trailing edge of the signature and a leading edge of a following signature. The instantaneous acceleration by the accelerator tapes sometimes results in signatures being marked by the accelerator tapes or being inconsistently presented to downstream processing components, resulting in fold skew and lap variation. Accelerator tapes also wear out quickly due to the rubbing action between the tape surface and the signature as the signature is being accelerated. Because of the rubbing action, accelerator tapes need to be replaced at fairly short intervals.

In conventional combination folders, once a signature is created the signature is transported or presented to a transfer or collect cylinder. Due to the size and complexity of transfer or collect cylinders, transfer or collect cylinders are typically designed for one cutoff length. Currently, in conventional combination folders small changes in cutoff length are accomplished by changing the percentage that acceleration tapes accelerate the signatures after creation. However, as the acceleration increases, accelerator tape wear substantially increases, the chance of damage to the signatures increases and large changes in cutoff length cannot be performed with a conventional combination folder without the signatures experiencing unacceptable damage.

### BRIEF SUMMARY OF THE INVENTION

A printing press is provided that includes at least one variable cutoff printing unit printing images of at least one cutoff length on a web, at least one cutting cylinder downstream of the at least one variable cutoff printing unit cutting the web into signatures. The printing press also includes a pair of first accelerator nip rolls receiving the web as the web is cut into the signatures and accelerating each of the signatures and at least one motor accelerating the pair of first accelerator nip rolls such that the first accelerator nip rolls have a first surface velocity equal to a velocity of the web as the web is received by the first accelerator nip rolls and the first accelerator nip rolls have a second surface velocity greater than the first surface velocity as the first accelerator nip rolls release each of the signatures.

A folder is also provided that includes at least cutting cylinder cutting a web into signatures and a pair of first accelerator nip rolls receiving the web as the web is cut into the signatures and accelerating each of the signatures. The folder also includes at least one motor accelerating the pair of first accelerator nip rolls such that the first accelerator nip rolls have a first surface velocity equal to a velocity of the web as the web is received by the first accelerator nip rolls and the first accelerator nip rolls have a second surface velocity greater than the first surface velocity as the first accelerator nip rolls release each of the signatures.

A method of operating a folder is also provided that includes the steps of driving at least one cutting cylinder according to at least one electronic cam cutting velocity profile to cut a web to create successive signatures based on at least one desired cutoff length and driving a pair of first accelerator nip rolls according to at least one electronic cam accelerating velocity profile so the pair of first accelerator nip rolls grip the web before each signature is created at a same velocity equal to a velocity of the web and accelerate the signatures as each signature is created. The electronic cam accelerating velocity profile is based on the at least one desired cutoff length and a desired spacing between the signatures downstream of the accelerator nip rolls.

### BRIEF DESCRIPTION OF THE DRAWINGS

The present invention is described below by reference to the following drawings, in which:

FIG. 1 shows a variable cutoff printing press according to an embodiment of the present invention;

FIG. 2 shows an embodiment of segmented cutting blades used in the variable cutoff printing press shown in FIG. 1;

FIG. 3 shows an example of ribbons including images of alternating cutoff lengths;

FIGS. 4a and 4b two consecutive signatures folded according to two different embodiments of the present invention;

FIG. 5 shows how signatures can be diverted into two separates streams according to one embodiment of the present invention;

FIG. 6a shows a graph illustrating exemplary velocity profiles for nip rolls accelerating signatures of the same length during consecutive revolutions; and

FIG. 6b shows a graph illustrating exemplary velocity profiles for nip rolls accelerating signatures of two different lengths during consecutive revolutions.

### DETAILED DESCRIPTION

Embodiments of the present invention may be used with a multigrain press (i.e., for producing both short grain products, which have a grain direction parallel to the longer sheet dimension, and long grain products, which have a grain direction parallel to the shorter sheet dimension), a variable cutoff printing press or multigrain variable cutoff printing press to fold, cut and deliver printed products of varying lengths. Using conventional folders with a multigrain press, a variable cutoff printing press or a multigrain variable cutoff printing press is not cost effective because conventional folders are designed to deliver printed products of one specific cutoff length, or within a very small range of cutoff lengths, requiring a plurality of folders to be used to deliver printed products of a plurality of cutoff lengths.

Embodiments of the present invention may eliminate the effects of the accelerator tapes rubbing on signatures and improve the consistency and accuracy of the head to tail spacing between successive signatures by accelerating signatures at a nip with an acceleration profile. Because the nip acceleration profile can be altered, embodiments of the present invention allow a fixed cutoff folder delivery or a former folder delivery to be used on multigrain and variable cutoff printing presses. Higher percentage accelerations may be achieved, providing an opportunity to create increased head to tail spacing of the signatures and thereby allowing processes that require greater head to tail spacing of the signatures to be performed on the signatures, such as diverting former folded signatures. Significantly reduced tape wear may also be accomplished.

Before a ribbon is cut into a signature, an accelerating nip having a surface velocity that is equal to the velocity of the ribbon contacts the ribbon. After the ribbon is cut into the signature, the accelerating nip is accelerated by utilizing an electronic cam with a controlled acceleration profile to accelerate the signature and create a spacing between a trailing edge of the signature and a leading edge of a following signature. Such a controlled acceleration profile may eliminate the consistency and accuracy problems associated with accelerator tapes. The signature is accelerated to the surface velocity of a downstream conveyor, which in a preferred embodiment is transport tapes, and then released at this velocity to the downstream conveyor, which may transport the signature to a diverter and subsequent delivery stations in a former folder or to a transfer or collect cylinder for jaw folding with a jaw cylinder.

Embodiments of the present invention may also be used to produce and transport signatures of alternating cutoff lengths or a series of a plurality of signatures that vary in cutoff length with respect to adjacent signatures. Conventional folders do not allow signatures of different lengths to be accelerated at different rates or consequently allow leading edges of signatures of different lengths to be presented to the same location during the same print job.

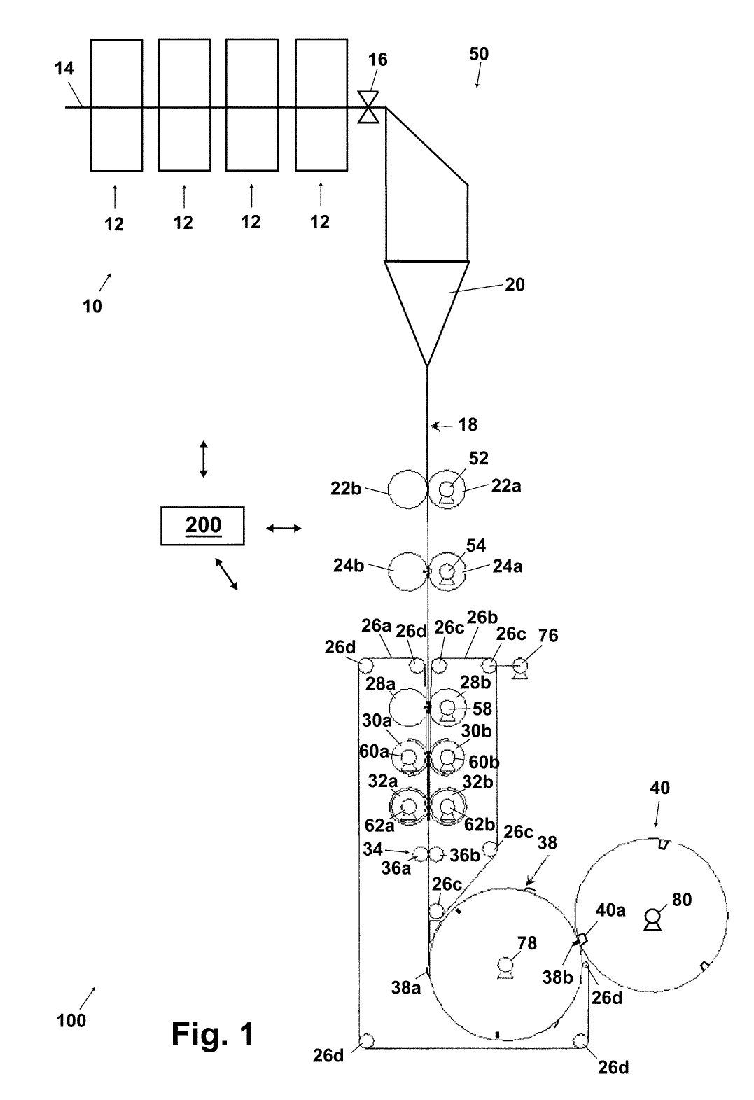

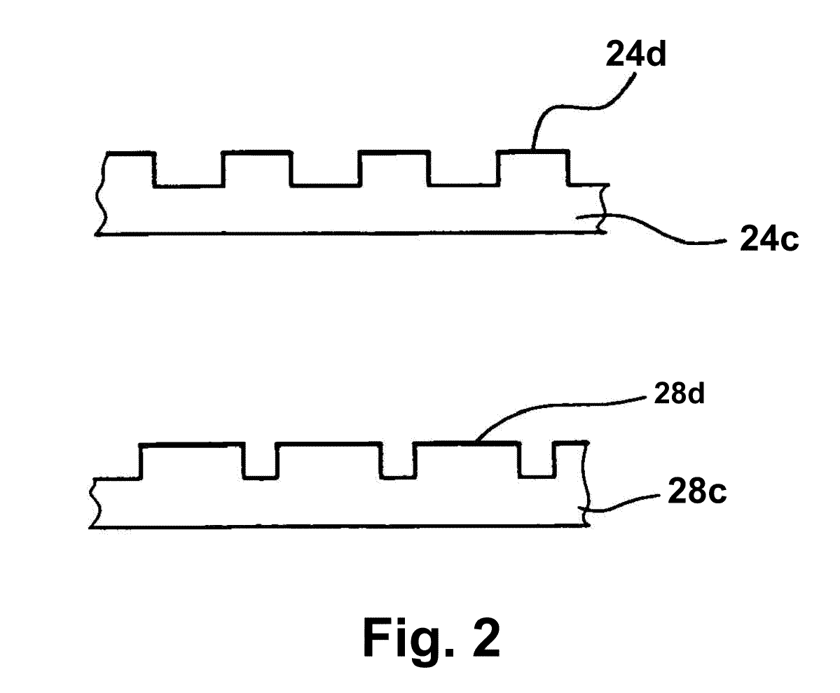

FIG. 1 shows a variable cutoff printing press 100 according to an embodiment of the present invention. Printing press 100 includes at least one printing section 10, which includes at least one variable cutoff printing unit 12 for printing on a web 14, and a folder 50 downstream of printing section 10. As shown in FIG. 1, printing section 10 includes four printing units 12 for printing four-colored images on web 12; however, printing section 10 may include more or less than four printing units 12. Printing units 12 may be digital printing units or offset lithographic printing units. A slitter 16 may be provided downstream of printing section 12 for slitting web 14 into two or more narrower webs or ribbons 18, which may be superimposed on top of one another and longitudinally folded by a former 20. In alternative embodiments, at least one of slitter 16 and former 20 may be omitted. Ribbons 18 are pulled away from printing section 12 (and optionally slitter 16 and/or former 20) by a pair of pull rolls 22a, 22b to a first cutting pair 24 including a first cutting cylinder 24a and a first anvil cylinder 24b. First cutting cylinder 24a includes a first segmented cutting blade 24c, which may be segmented as shown in FIG. 2. First segmented cutting blade 24c may include axially spaced blade edges 24d that form partial first cuts in ribbons 18 each time cutting blade 24c rotates around a center axis of first cutting cylinder 24a and contacts first anvil cylinder 24b.

Downstream of first cutting pair 24a, 24b, ribbons 18 enter in between two sets transport tapes 26a, 26b extending on opposites sides of ribbons 18; however, transport tapes 26a, 26b do not grip ribbons 18 until after ribbons 18 have been cut into signatures and accelerated. A second cutting pair 28 cuts ribbons 18 in between the first partial cuts made by first segmented cutting blade 24c to separate ribbons 18 into signatures. Second cutting pair 28 includes a second cutting cylinder 28a and a second anvil cylinder 28b. The second cutting cylinder 28a includes a second segmented cutting blade 28c, which may be segmented as shown in FIG. 2. Second segmented cutting blade 28c may include axially spaced blade edges 28d that form the partial second cuts in ribbons 18 each time cutting blade 28c rotates around second cutting cylinder 28a and contacts first second cylinder 28b. As schematically shown in FIG. 2, first and second blade edges 24d, 28d are arranged with respect to each other in the web travel direction such that second blade edges 28d cut ribbons 18 in the locations that first blade edges 24d do not cut ribbons 18 to complete the cut started by first blade edges 24d and separate ribbons 18 into signatures.

Before ribbons 18 are cut by second cutting cylinder 28a to form a trailing edge of a signature, a leading edge of ribbons 18 (i.e., a leading edge of the signature being created) is gripped by a pair of first accelerator nip rolls 30a, 30b. Accelerator nips rolls 30a, 30b are driven such that the surfaces of accelerator nip rolls 30a, 30 contact ribbons 18 before signature creation such that as accelerator nip rolls 30a, 30b contact ribbons 18, a surface velocity of accelerator nips rolls 30a, 30b equals a velocity of ribbons 18. After segmented blade 28c cut ribbons 18, accelerator nip rolls 30a, 30b are accelerated to accelerate the newly created signature and separate a trailing edge of the signature from a leading edge of ribbons 18 (which will form a leading edge of the following signature). In one embodiment, nip rolls 30a, 30b may be configured in the same manner as the rollers shown in FIGS. 2, 4, 6 and 8 of commonly owned U.S. Pub. 2009/0217833, which is hereby incorporated by reference herein, and may include axially spaced segments of nip material mounted on only a portion of a circumference thereof. In another embodiment, nip rolls 30a, 30b may be configured in the same manner as the rollers shown in FIGS. 7 and 9 of commonly owned U.S. Pub. 2009/0217833 and may include axially spaced segments of nip material mounted on an entire circumference thereof. After the signature is accelerated by accelerator nip rolls 30a, 30b, the signature may then be delivered from accelerator nip rolls 30a, 30b to an optional pair of second accelerator nip rolls 32a, 32b, which may further accelerate the signature to increase the head to tail signature spacing. In a preferred embodiment, nip rolls 32a, 32b may be configured in the same manner as the rollers shown in FIGS. 7 and 9 of commonly owned U.S. Pub. 2009/0217833 and have nip material mounted on an entire circumference thereof.

Transport tapes 26a, 26b guide ribbons 18 before ribbons 18 are cut by second cutting cylinder 28a and as the signatures are accelerated by the pair of first accelerator nip rolls 30a, 30b and the pair of second accelerator nip rolls 32a, 32b and then positively grip and take control of the signatures downstream of accelerator nip rolls 32a, 32b at a location 34 where transport tapes 26a, 26b are brought together by a pair of rolls or pulleys 36a, 36b. Transport tapes 26a, 26b, which are spaced apart from each other upstream of location 34 and are traveling at a higher velocity than the signatures, guide the signatures by contacting the signatures that stray away from the transport plane and forcing the signatures quickly back into the transport plane. Transport tapes 26a, 26b are guided by respective sets of rollers or pulleys 26c, 26d such that transport tapes 26a extend around cutting cylinder 28a and nip rolls 30a, 32a and transport tapes extend around anvil cylinder 28b and nip rolls 30b, 32b. Cylinders 28a, 28b and nip rolls 30a, 30b, 32a, 32b may include relieved portions axially spaced thereon for receiving and guiding transport tapes 26a, 26b. Transport tapes 26a, 26b are traveling around pulleys 26c, 26d at a surface velocity that is greater than the velocity that ribbons 18 are traveling. In embodiments including accelerator nip rolls 32a, 32b, transport tapes 26a, 26b are velocity matched to the exit velocity of accelerator nip rolls 32a, 32b so that transport tapes 26a, 26b have a surface velocity equal to the surface velocity of accelerator nip rolls 32a, 32b as the signatures being transported by accelerator nip rolls 32a, 32b enter into location 34. In embodiments not including accelerator nip rolls 32a, 32b and signatures are transported directly from nip rolls 30a, 30b to transport tapes 26a, 26b, transport tapes 26a, 26b are velocity matched to the exit velocity of accelerator nip rolls 30a, 30b so that transport tapes 26a, 26b have a surface velocity equal to the surface velocity of accelerator nip rolls 30a, 30b as the signatures being transported by accelerator nip rolls 30a, 30b enter into location 34.

Transport tapes 26a, 26b deliver the signatures to a collect cylinder 38 for jaw folding by a jaw cylinder 40 and subsequent folding and processing operations. The downstream pulleys 26c are positioned such that transport tapes 26a follow a path along a portion of the circumference of collect cylinder 38. Grippers 38a on collect cylinder 38 grip and transport the signatures away from transport tapes to jaw cylinder 40. Grippers 38a, which are axially offset from tapes 26a, grip signatures 18 until collect cylinder 38 is rotated such that a leading edge of each signature is moved past a minimum gap between collect cylinder 38 and jaw cylinder 40. Tucker blades 38b on collect cylinder 38 then contact the signatures and force the signatures into corresponding folding jaws 40a on jaw cylinder 40 such that tucker blades 38b and folding jaws 40a cooperate to cross-fold each signature at a center line thereof. The cross-folded signatures are then released from jaw cylinder 40 onto a delivery, which may transport the signatures to further processing equipment. In an alternative embodiment, transport tapes 26a, 26b may deliver the signatures to a diverting and delivery station or stations in a former folder.

In an alternative embodiment, instead of transport tapes 26a, 26b guiding signatures in the areas of cylinders 28a, 28b and nip rolls 30a, 30b, 32a, 32b and upstream of location 34, static guides may be provided on opposite sides of the transport plane to limit movement of signatures with respect to the transport plane.

In order to provide increased control over the signature creation and signature transport processes, electronic cam velocity profiles are used to control components of folder 50. In particular, cutting cylinders 24a, 28a may be driven by respective motors 54, 58, which in a preferred embodiment are servo motors, according to electronic cam cutting velocity profiles by a controller 200. The cutoff lengths of signatures to be produced by folder 50, which correspond to the images printed by printing units 12, may be provided directly or indirectly to controller 200 by a press operator. Controller 200 may then access or generate the corresponding electronic cam cutting velocity profiles that allow cutting cylinders 24a, 28a to be properly phased such that cutting blades 24c, 28c contact ribbons 18 at the proper location and at the proper velocity to create signatures of the desired cutoff length or lengths. Unless the desired cutoff length of signatures to be created by cutting cylinders 24a, 28a is equal to the effective circumferences of cutting cylinders 24a, 28a, cutting cylinders 24a, 28a are rotated at varying velocities during each revolution to create the signatures. In order for cutting cylinders 24a, 28a to create signatures having a cutoff length that is less than the effective circumference of cutting cylinders 24a, 28a, cutting cylinders 24a, 28a are accelerated after respective cutting blades 24c, 28c contact ribbons 18. In order for cutting cylinders 24a, 28a to create signatures having a cutoff length that is greater than the effective circumference of cutting cylinders 24a, 28a, cutting cylinders 24a, 28a are decelerated after respective cutting blades 24c, 28c contact ribbons 18. Controller 200 may also control cutting cylinders 24a, 28a to cut signatures of alternating lengths (i.e., a first signature of a first length directly followed by a second signature of a second length) by controlling cutting cylinders 24a, 28a according to electronic cam cutting velocity profiles that cause cutting cylinders 24a, 28a to be rotated differently during consecutive revolutions. For example, if the first signature has a greater cutoff length than the second signature, cutting cylinders 24a, 28a are rotated at a lower average velocity during the first revolution, at the end of which a trailing edge of the first signature is formed, than the second revolution, at the end of which a trailing edge of the second signature is formed.

Similarly, accelerator nip rolls 30a, 30b may be driven by respective motors 60a, 60b and accelerator nip rollers 32a, 32b may be driven by respective motors 62a, 62b, which in a preferred embodiment are all servo motors, according to electronic cam accelerating velocity profiles by controller 200. Controller 200 may access or generate the corresponding electronic cam accelerating velocity profiles for controlling motors 60a, 60b such that accelerator nip rolls 30a, 30b have a surface velocity equal to the velocity of ribbons 18 as accelerator nip rolls 30a, 30b first contact a leading edge of each signature to be created and such that accelerator nip rolls 30a, 30b accelerate each signature after cutting blade 28c cuts ribbons 18 and separates each signature from ribbons 18. Accordingly, after accelerator nip rolls 30a, 30b release one signature accelerator nip rolls 30a, 30b are decelerated to match the surface of nip rolls 30a, 30b to the velocity of ribbons 18. The electronic cam accelerating velocity profiles for controlling motors 60a, 60b are set based on a velocity of ribbons 18, the cutoff length of the signature being accelerated and the desired spacing of the signature from the following signature and the preceding signature as the signature exits nip rolls 30a, 30b. Controller 200 may also access or generate the corresponding electronic cam accelerating velocity profiles for controlling motors 62a, 62b such that accelerator nip rolls 32a, 32b have a surface velocity equal to the velocity of the signatures entering accelerator nip rolls 32a, 32a from accelerator nip rolls 30a, 30b as accelerator nip rolls 32a, 32b first contact a leading edge of each signature and such that accelerator nip rolls 32a, 32b accelerate each signature after the signatures are released by accelerator nip rolls 30a, 30b. The electronic cam accelerating velocity profiles for controlling motors 62a, 62b are set based on an incoming velocity of the signature, the cutoff length of the signature being accelerated and the desired spacing of the signature from the following signature and the preceding signature as the signature exits nip rolls 32a, 32b. In embodiments where signatures being accelerated by nip rolls 30a, 30b, 32a, 32b have a length that is greater than the distance between a nip of rolls 30a, 30b and a nip of rolls 32a, 32b, controller 200 velocity matches rolls 30a, 30b with rolls 32a, 32b such that rolls 30a, 30b have the same surface velocity as rolls 32a, 32b while both rolls 30a, 30b and rolls 32a, 32b are accelerating one signature together.

Controller 200 may also control the operation of printing units 12. In one embodiment, printing units 12 may be offset lithographic printing units, each including an upper blanket cylinder, an upper plate cylinder, a lower blanket cylinder and a lower plate cylinder. Between one and four motors may be provided for driving each printing unit, with the motors being controlled by controller 200. In a preferred embodiment, removable sleeves may be used in printing units 12 to allow printing units 12 to accommodate printing plates and printing blankets of varying cutoff lengths. Plate cylinders and blanket cylinders may each include a base cylinder or mandrel, a sleeve that is slid over the outer surface of the mandrel and a plate or blanket that is wrapped around or slid over the sleeve (i.e., sleeves are similar to the sleeves described in incorporated by reference U.S. Pat. No. 5,813,336). For example, during a cutoff change, a blanket cylinder sleeve mounted on the blanket cylinder mandrel is then slid off of the blanket cylinder mandrel. A blanket mounted on the blanket cylinder sleeve may be removed before or after the blanket cylinder sleeve is slid off of the blanket cylinder mandrel. A different blanket cylinder sleeve having a larger or small outer circumference may then be mounted on the blanket cylinder mandrel. A new blanket may be mounted on the different blanket cylinder sleeve before or after the different blanket cylinder sleeve is slid onto the blanket cylinder mandrel. Removal and replacement of plate cylinders during cutoff changes may occur in the same manner, but with printing plates being mounted on the sleeves instead of blankets.

In another embodiment, printing units 12 may be digital printing units, for example an electrophotographic or ink jet printing engines, printing on both sides of web 14. Controller 200, which may include a memory that stores information regarding the content to be printed on web 14, may control printing units 12 to ensure that the proper content is printed as desired on web 14. In a further embodiment, printing units 12 may be flexographic printing units, the motors of which are controlled by controller 200.

Controller 200 may further control at least one motor 52 driving pull rollers 22a, 22b, at least one motor 76 driving transport tapes 26a, 26b, a motor 78 driving collect cylinder 38 and a motor 80 driving jaw cylinder 40. Controlling of all of motors 52, 54, 58, 60a, 60b, 62a, 62b, 76, 78, 80 in folder 50 via controller 200 allows ribbons 18 and signatures to be processed and transported in a fluid and highly controlled manner, allowing gradual velocity changes and preventing or minimizing product damage. Additionally, the arrangement of folder 50 may allow folder 50 to be easily adjusted to accommodate signatures of varying cutoff lengths. Adjusting folder 50 to handle signatures of different cutoff lengths may merely require adjusting the phasing and velocity of motors 52, 54, 58, 60a, 60b, 62a, 62b, 76, 78, 80 and varying the electronic cam velocity profiles used to drive motors 54, 58, 60a, 60b, 62a, 62b.

In an alternative embodiment, the electronic cam velocity profiles used to control components of folder 50 may be stored in individual drivers or controllers other than controller 200, which may control the individual drivers or controllers.

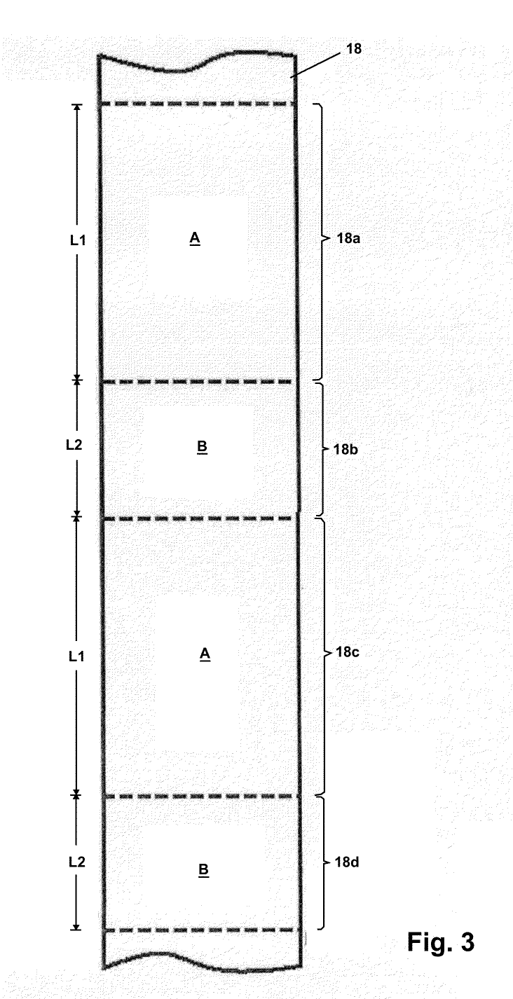

In one embodiment of the present invention, printing press 100 may produce signatures that vary in cutoff length with respect to adjacent signatures. Printing section 10 may print images on web 14 (later slit into ribbons 18) that vary in length with respect to adjacent images and cutting cylinders 24a, 28a may be phased to cut successive signatures that vary in length with respect to adjacent signatures. FIG. 3 shows an example of ribbons 18 including images of alternating cutoff lengths. A first portion 18a of ribbons 18 includes a first image A of a first cutoff length L1, a second portion 18b of ribbons 18 directly following first portion 18a includes a second image B of a second cutoff length L2 that is less than the first cutoff length L1, a third portion 18c of ribbons 18 directly following second portion 18b includes a third image A of the first cutoff length L1 and a fourth portion 18d of ribbons 18 directly following third portion 18c includes a fourth image B of the second cutoff length L2. In embodiment where printing units 12 (FIG. 1) are offset lithographic printing units, one or more printing plates on printing cylinders may include impressions of both of images A, B on the circumference thereof, allowing printing units 12 to print images A and B on ribbons web 14 (later slit into ribbons 18) during each revolution of the plate and blanket cylinders. In embodiment where printing units 12 are digital printing units, controller 200 may direct printing units 12 to print varying images of varying lengths continuously on web 14. For example, images A in portions 18a, 18c may include the same content as each other or may include customized content and images B in portions 18b, 18d may include the same content as each other or may include customized content.

Referring to both FIGS. 1 and 3, controller 200 may control motors 54, 58 driving cutting cylinders 24a, 28a based on electronic cam cutting profiles that allow each of cutting cylinders 24a, 28a to be accelerated and decelerated in one manner in a first revolution and then accelerated and decelerated in a different manner in the next revolution. For example, if images A have a cutoff length that is greater than the effective circumference of each of cutting cylinders 24a, 28a, after cutting a leading edge of first portion 18a, in order for cutting blades 24c, 28c to complete a full revolution in the time it takes for ribbons 18 travel the distance of first cutoff length L1, cutting cylinder 24a, 28a are decelerated such that the velocity of the tip of each of blades 24c, 28c is less than the velocity of ribbons 18, but then accelerated such that the velocity of the tip of each of blades 24c, 28c is equal to the velocity of ribbons 18 at the end of the revolution as blades 24c, 28c cut ribbons 18 at the trailing edge of first portion 18a and the leading edge of second portion 18b. If images B have a cutoff length that is less than the effective circumference of each of cutting cylinders 24a, 28a, after cutting trailing edge of first portion 18a and the leading edge of second portion 18b, in order for cutting blades 24c, 28c to complete a full revolution before ribbons 18 travel the distance of second cutoff length L2, cutting cylinder 24a, 28a are accelerated such that the velocity of the tip of each of blades 24c, 28c is greater than the velocity of ribbons 18, but then decelerated such that the velocity of the tip of each of blades 24c, 28c is equal to the velocity of ribbons 18 at the end of the revolution as blades 24c, 28c cut ribbons 18 at the trailing edge of second portion 18b and the leading edge of third portion 18c. Motors 54, 58 may accordingly be operated with such an electronic cam velocity profile, one having an alternating velocity path every other revolution, for as long as images A, B having cutting lengths L1, L2 are alternately printed on ribbons 18. In alternative embodiments, signatures may be printed with more than two successive images that varying in cutoff length. For example, three or more successive images may be repeatedly printed and formed into signatures of three or more different lengths, (i.e., signatures A1, B1, C1 all of different lengths, then signatures A2, B2, C2 of the same length as signatures A1, B1, C1, respectively).

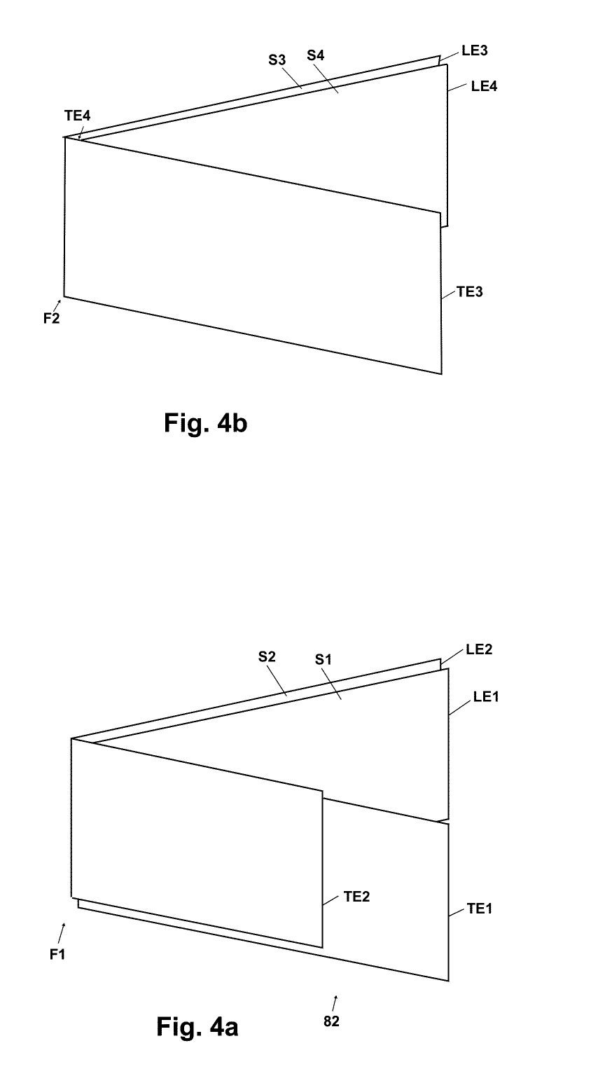

FIGS. 4a and 4b two consecutive signatures folded according to two different embodiments of the present invention. In FIG. 4a, a first signature S1 having one cutoff length and a second signature S2 having another cutoff length less than the cutoff length of the first signature S1, are aligned with each and folded together. The images of first signature S1 and second signature S2 are printed directly adjacent to one another on web 14 by printing units 12 and cut into successive signatures as described above with respect to FIGS. 1 and 3, with motors 54, 58 rotating cutting cylinders 24a, 28a differently (and at different average velocities) in consecutive revolutions. Referring to folder 50 in FIG. 1, after ribbons 18 are cut to create signature S1 and then signature S2, the leading edges LE1, LE2 of signatures S1, S2 may be aligned with each other using accelerator nip rolls 30a, 30b, accelerator nip rolls 32a, 32b and transport tapes 26a, 26b. To align leading edges LE1, LE2 of signatures S1, S2 in such a manner, signature S1 may be formed directly ahead of signature S2 and signature S2 may be indexed forward such that the leading edge LE2 of signature S2 and the leading edge LE1 of signature S1 are gripped by grippers 38a at the same position on collect cylinder 38. This is preferably accomplished by phasing cylinders 30a, 30b, 32a, 32b and collect cylinder 38 with respect to each other such that signature S1 is first gripped by collect cylinder 38, held by collect cylinder 38 for a full revolution and then signature S2 is gripped by collect cylinder 38 in the next revolution, such that the leading edge LE2 of signature S2 and the leading edge LE1 of signature S1 are gripped by grippers 38a at the same position on collect cylinder 38. The aligning of leading edges LE1, LE2 of signatures S1, S2 causes a trailing edge TE1 of signature S1 to extend past a trailing edge TE2 of signature S2 as signatures S1, S2 are rotated into the gap between collect cylinder 38 and jaw cylinder 40 for folding. Signatures S1, S2 are then folded together by tucker blades 38b on collect cylinder 38 by contacting signatures S1, S2 and forcing the signatures into corresponding folding jaws 40a on jaw cylinder 40 at a fold line F1, creating a false lap 82 at trailing edges TE1, TE2.

In FIG. 4b, a third signature S3 having one cutoff length and a fourth signature S4 having another cutoff length approximately equal to half of the cutoff length of the third signature S4, are aligned. Third signature S3 and fourth signature S4 are printed directly adjacent to one another on web 14 by printing units 12 and cut into successive signatures as described above with respect to FIGS. 1 and 3, with motors 54, 58 rotating cutting cylinders 24a, 28a at twice the average velocity per revolution to cut signature S4 than to cut signature S3. Leading edges LE3, LE4 of signatures S3, S4 may be aligned with each other using folder 50 shown in FIG. 1. To align leading edges LE3, LE4 of signatures S3, S4 in such a manner, signature S3 may be formed directly ahead of signature S4 and signature S4 may be indexed forward such that the leading edge LE4 of signature S4 and the leading edge LE3 of signature S3 are gripped by grippers 38a at the same position on collect cylinder 38. The aligning of leading edges LE3, LE4 of signatures S3, S4 causes a trailing edge TE3 of signature S3 to be aligned approximate to the halfway of the length of signature S4 as signatures S3, S4 are rotated into the gap between collect cylinder 38 and jaw cylinder 40 for folding. Signature S3 is folded by tucker blades 38b on collect cylinder 38 contacting a middle of signature S3 and forcing a trailing edge TE4 of signature S4 and the middle of signature S3 into corresponding folding jaws 40a on jaw cylinder 40 to create a fold line F2 in signature S3, which aligns with trailing edge TE4 of signature S4, creating a delta folded product on jaw folder 40 without using an additional jaw folding cylinder.

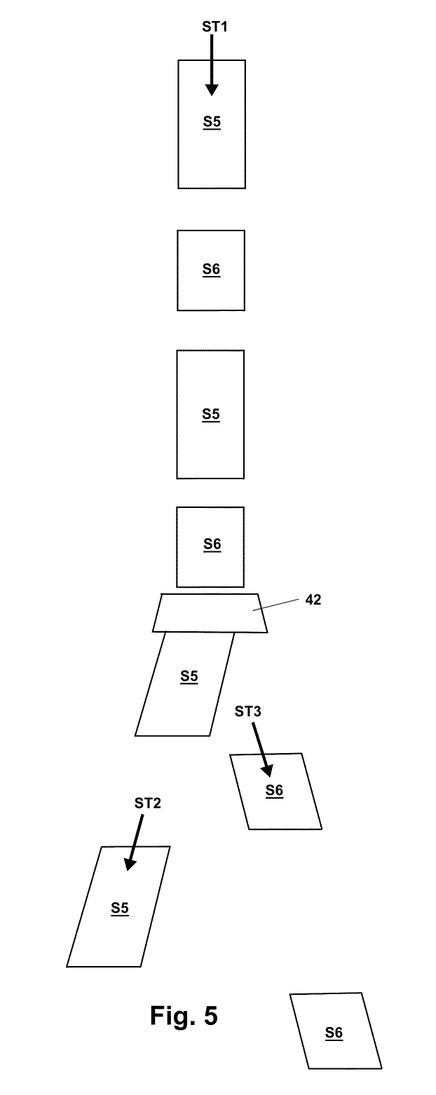

FIG. 5 shows how signatures can be diverted into two separates streams downstream of transport tapes 26a, 26b in FIG. 1 according to one embodiment of the present invention. Fifth signatures S5 having one cutoff length and sixth signatures S6 having another cutoff length less than the cutoff length of fifth signatures S5 are alternately created using folder 50 shown in FIG. 1. In order to space signatures S5, S6 traveling in a first stream ST1 from each other and present signatures S5, S6 to a schematically shown diverter 42 for diverting signatures S5 into a second stream ST2 and signatures S6 into a third stream ST3, acceleration nip rollers 30a, 30b and optionally acceleration nip rollers 32a, 32b may index signatures S5, S6 accordingly.

In order to accelerate consecutive signatures of different lengths, such as those discussed above with respect to FIGS. 3, 4a, 4b, 5, accelerator nip rolls 30a, 30b and nip rolls 32a, 32b may be rotated by motors 60a, 60b, 62a, 62b differently for a number of revolutions. For example, referring to FIG. 5, because signatures S5 have a larger cutoff length than signatures S6, nip rolls 30a, 30b and nip rolls 32a, 32b are driven differently when accelerating signatures S5 than signatures S6. If the cutoff length of signature S5 is longer than the circumferences of nip rolls 30a, 30b, 32a, 32b (and where nip rolls 30a, 30b, 32a, 32b have nip material mounted on an entire circumference thereof), nip rolls 30a, 30b, 32a, 32b are accelerated for more than a single revolution before nip rolls 30a, 30b, 32a, 32b are decelerated to receive the following signature S6. If the cutoff length of signature S6 is shorter than the circumferences of nip rolls 30a, 30b, 32a, 32b, nip rolls 30a, 30b, 32a, 32b are accelerated for less than a single revolution before nip rolls 30a, 30b, 32a, 32b are decelerated to receive the following signature S5. Accordingly, where nip rolls 30a, 30b, 32a, 32b have nip material mounted on an entire circumference thereof controller 200 sets the electronic cam accelerating velocity profiles of motors 60a, 60b, 62a, 62b, not based on rotational positions of nip rolls 30a, 30b, 32a, 32b, but based on the length of the signature being accelerated and the desired spacing between the signature and adjacent signatures. In contrast, when nip rolls 30a, 30b have nip material mounted on only a portion of a circumference thereof, the rotational positions of nip rolls 30a, 30b, 32a, 32b are taken into consideration for setting the electronic cam accelerating velocity profiles of motors 60a, 60b.

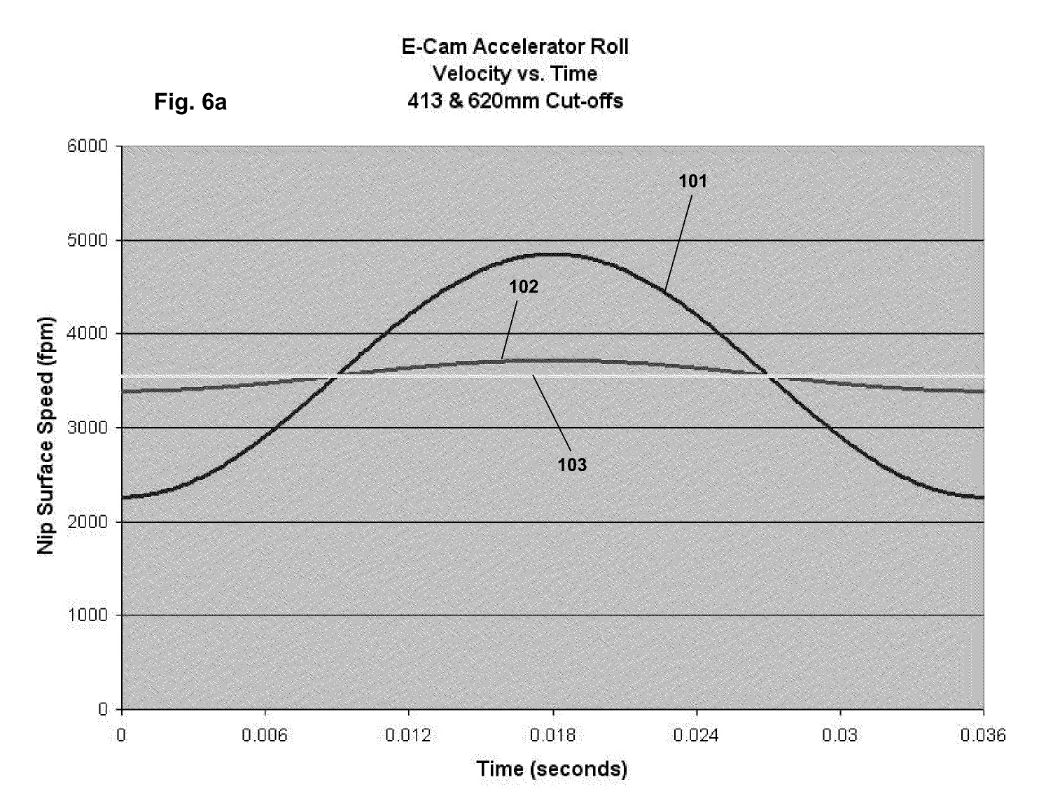

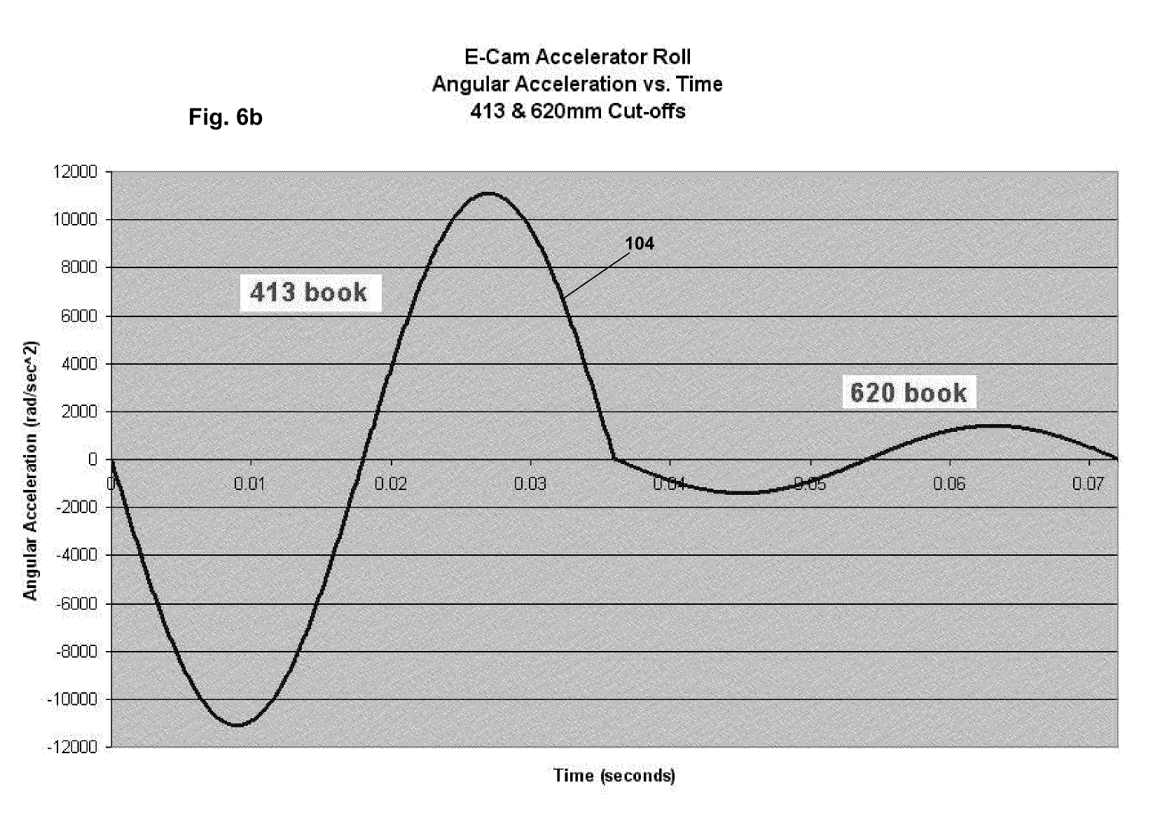

FIG. 6a shows a graph illustrating exemplary velocity profiles for either one of the first pair of nip rolls 30a, 30b (FIG. 1) or the second pair of nip rolls 32a, 32b (FIG. 1) accelerating signatures of the same length during consecutive revolutions. The graph is a plot of nip surface velocity in feet per minutes versus time in seconds. A first line 101 shows a change in the nip surface velocity profile for one revolution for accelerating signatures having a 413 mm cutoff length. A second line 102 shows a change in the nip surface velocity profile for one revolution for accelerating signatures having a 620 mm cutoff length. A line 103 shows an average nip surface velocity for the velocity profiles shown by lines 101, 102.

FIG. 6b shows a graph illustrating exemplary acceleration profiles for either one of the first pair of nip rolls 30a, 30b (FIG. 1) or the second pair of nip rolls 32a, 32b (FIG. 1) accelerating signatures of two different lengths during consecutive revolutions. The graph is a plot of angular acceleration in radians per second squared versus time in seconds. A line 104 shows a change in the nip acceleration profile for two revolutions for accelerating two different signatures. A first revolution of nip rolls 30a, 30b or 32a, 32b occurs between 0 seconds and approximately 0.036 seconds. Nip rolls 30a, 30b or 32a, 32b are decelerated between 0 seconds and approximately 0.018 seconds, a period in which nip rolls 30a, 30b or 32a, 32b do not contact a signature. At approximately 0.018 seconds, nip rolls 30a, 30b or 32a, 32b contact an incoming signature having a 413 mm cutoff length and have a surface velocity equal to the velocity of the 413 mm signature. After nip rolls 30a, 30b or 32a, 32b contact the 413 mm signature, between approximately 0.018 and 0.036 seconds, nip rolls 30a, 30b or 32a, 32b are accelerated to accelerate the 413 mm signature. Then, in a second revolution of nip rolls 30a, 30b or 32a, 32b occurs between approximately 0.036 and 0.072 seconds. Nip rolls 30a, 30b or 32a, 32b are decelerated between 0.036 seconds and approximately 0.054 seconds, a period in which nip rolls 30a, 30b or 32a, 32b do not contact a signature. At approximately 0.054 seconds, nip rolls 30a, 30b or 32a, 32b contact an incoming signature having a 620 mm cutoff length and have a surface velocity equal to the velocity of the 620 mm signature. After nip rolls 30a, 30b or 32a, 32b contact the 620 mm signature, between approximately 0.054 and 0.072 seconds, nip rolls 30a, 30b or 32a, 32b are accelerated to accelerate the 620 mm signature.

It should be noted that nip rolls 30a, 30b, 32a, 32b (FIG. 1) being operated according to the velocity profiles in FIGS. 6a, 6b preferably only include nip material mounted on only a portion of a circumference thereof such that the portion of the circumference without nip material is relieved with respect to the nip material. This allows nip rolls 30a, 30b, 32a, 32b to be out of contact with signatures during the deceleration phase of each revolution.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing press comprising:
at least one variable cutoff printing unit printing images of at least one cutoff length on a web;
at least one cutting cylinder downstream of the at least one variable cutoff printing unit cutting the web into signatures;
a pair of first accelerator nip rolls receiving the web before the web is cut into the signatures and accelerating each of the signatures; and
at least one motor accelerating the pair of first accelerator nip rolls such that the first accelerator nip rolls have a first surface velocity equal to a velocity of the web as the web is received by the first accelerator nip rolls and the first accelerator nip rolls have a second surface velocity greater than the first surface velocity as the first accelerator nip rolls release each of the signatures.

2. The printing press recited in claim 1 wherein the at least one motor accelerating the pair of first accelerator nip rolls drives the pair of first accelerator nip rolls according to a first electronic cam accelerating velocity profile, the electronic cam accelerating velocity profile being based on the at least one cutoff length and a desired spacing between the signatures downstream of the first accelerator nip rolls.

3. The printing press recited in claim 2 further comprising at least one motor driving the at least one cutting cylinder according to at least one electronic cam cutting velocity profile, the at least one electronic cam cutting velocity profile being based on the at least one cutoff length.

4. The printing press recited in claim 3 further comprising at least one controller receiving the at least one cutoff length of the images printed by the at least one variable cutoff printing unit on the web and setting the at least one electronic cam accelerating velocity profile based on the least one cutoff length and the desired spacing between the signatures downstream of the first accelerator nip rolls.

5. The printing press as recited in claim 4 wherein the at least one variable cutoff printing unit prints at least two successive images of different cutoff lengths and the at least one electronic cam accelerating velocity profile is set by the at least one controller such that the first accelerator nip rolls are driven differently in at least two successive revolutions.

6. The printing press recited in claim 4 where the at least one controller sets the at least one electronic cam cutting velocity profile based on the least one cutoff length.

7. The printing press as recited in claim 6 wherein the at least one variable cutoff printing unit prints at least two successive images of different cutoff lengths and the at least one electronic cam cutting velocity profile is set by the at least one controller such that the at least one cutting cylinder is driven differently in at least two successive revolutions.

8. The printing press recited in claim 1 further comprising a pair of second accelerator nip rolls downstream of the pair of first accelerator nip rolls and at least one motor driving the pair of second accelerator nip rolls according to a second electronic cam accelerating velocity profile, the second electronic cam accelerating velocity profile being based on the at least one cutoff length and a desired spacing between the signatures downstream of the second accelerator nip rolls.

9. The printing press recited in claim 8 further comprising transport tapes gripping the signatures downstream of the pair of second accelerator nip rolls and at least one motor driving the transport tapes such that the transport tapes have a surface velocity equal to a velocity the signatures are released by the second accelerator nip rolls.

10. The printing press recited in claim 1 further comprising transport tapes gripping the signatures downstream of the pair of first accelerator nip rolls and at least one motor driving the transport tapes such that the transport tapes have a surface velocity equal to a velocity the signatures are released by the first accelerator nip rolls.

11. The printing press recited in claim 10 further comprising a collect cylinder downstream of the transport tapes receiving the signatures from the transport tapes.

12. The printing press recited in claim 11 wherein the pair of first accelerator nip rolls accelerates two successive signatures such that leading edges of both of the two successive signatures are received by the pair of first accelerator nip rolls at the same time.

13. The printing press recited in claim 12 further comprising a jaw cylinder downstream of the collect cylinder cooperating with the collect cylinder to fold the two successive signatures at the same time to form a false lap.

14. The printing press recited in claim 12 further comprising a jaw cylinder downstream of the collect cylinder cooperating with the collect cylinder to fold the two successive signatures at the same time to form a delta folded product.

15. The printing press recited in claim 10 further comprising a diverter downstream of the transport tapes, the pair of first accelerator nip rolls accelerating signatures of alternating lengths and the diverter diverting the signatures based on length.

16. A folder comprising:
at least one cutting cylinder cutting a web into signatures of at least one cutoff length;
a pair of first accelerator nip rolls receiving the web as the web is cut into the signatures and accelerating each of the signatures; and
at least one motor accelerating the pair of first accelerator nip rolls such that the first accelerator nip rolls have a first surface velocity equal to a velocity of the web as the web is received by the first accelerator nip rolls and the first accelerator nip rolls have a second surface velocity greater than the first surface velocity as the first accelerator nip rolls release each of the signatures.

17. A method of operating a folder comprising:
driving at least one cutting cylinder according to at least one electronic cam cutting velocity profile to cut a web to create successive signatures based on at least one desired cutoff length;
driving a pair of first accelerator nip rolls according to at least one electronic cam accelerating velocity profile so the pair of first accelerator nip rolls grip the web before each signature is created at a same velocity equal to a velocity of the web and accelerate the signatures as each signature is created, the electronic cam accelerating velocity profile being based on the at least one desired cutoff length and a desired spacing between the signatures downstream of the accelerator nip rolls.

18. The method recited in claim 17 wherein the at least one electronic cam cutting velocity profile is such that two successive signatures have different cutoff lengths than each other.

19. The method recited in claim 18 wherein the at least one electronic cam accelerating velocity profile is such that the two successive signatures having different cutoff lengths than each other are accelerated differently than each other.

20. The method recited in claim 19 further comprising folding the two successive signatures having different cutoff lengths together.
